(19) United States
(12) Patent Application Publication
(10) Pub. No.: US 2024/0300528 A1
(43) Pub. Date: Sep. 12, 2024

(54) SYSTEMS AND METHODS FOR ESTIMATING A STATE FOR POSITIONING AUTONOMOUS VEHICLES TRANSITIONING BETWEEN DIFFERENT ENVIRONMENTS

(71) Applicant: LoopX Innovation Inc., Waterloo (CA)

(72) Inventors: Chao YU, Waterloo (CA); Haomin ZHENG, Waterloo (CA); Jinwei ZHANG, Waterloo (CA); Yaodong CUI, Waterloo (CA); Shucheng HUANG, Waterloo (CA); Jiaming ZHONG, Waterloo (CA); Amir KHAJEPOUR, Waterloo (CA)

(21) Appl. No.: 18/600,238

(22) Filed: Mar. 8, 2024

Related U.S. Application Data
(60) Provisional application No. 63/451,248, filed on Mar. 10, 2023.

(51) Int. Cl. B60W 60/00

(52) U.S. Cl. CPC B60W 60/001; B60W 2420/403; B60W 2420/408; B60W 2556/50

(57) ABSTRACT

Various methods and systems for determining one or more states of an autonomous vehicle for positioning when transitioning between two or more different environments are disclosed herein. The systems and methods disclosed herein can include a positioning system that includes two or more different positioning subsystems operable to generate positional data representing a current position of the autonomous vehicle. The systems and methods disclosed involve receiving positional data from each positioning subsystem, pre-processing the positional data based on a common frame of reference determined for the autonomous vehicle, generating estimated current states for the autonomous vehicle determining weighting values for the positioning subsystems based on the estimated current states, and applying a weighting value generated for a positioning subsystem to a corresponding estimated current state generated for the positional data collected by the positioning subsystem to estimate a position of the vehicle when transitioning between two or more different environments.

### CROSS-REFERENCE TO RELATED PATENT APPLICATION

The application claims the benefit of U.S. Provisional Application No. 63/451,248, filed on Mar. 10, 2023. The complete disclosure of U.S. Provisional Application No. 63/451,248 is incorporated herein by reference.

### FIELD

The described embodiments relate to a system for determining a state of an autonomous vehicle using data fusion, and methods of operating thereof.

### BACKGROUND

High-precision and robust positioning systems are crucial for localization of robotics and autonomous driving systems. Various different systems, which can include different types of sensor systems, exist for providing position and kinematic estimation. For example, global navigation satellite systems (GNSS), inertial measurement units (IMU), wheel odometry, point cloud matching, visual localization can be used for estimating a state of a robotics or autonomous driving system. Under different environmental settings, each sensor system can show, at least, a different scale of precision.

Existing systems, however, are often not equipped for handling changes in driving systems' environments. For example, existing systems can be unsuited for movement from indoor to outdoor environments, such as moving a mining-related vehicle from underground mines to open pits, since separate systems are typically used for localizing a vehicle in indoor and outdoor environments. As another example, movement from a less urbanized area to city center can impact the accuracy and precision of existing positioning systems, since the signal of GNSS typically used for outdoor localization can be downgraded by the dense buildings.

### SUMMARY

The various embodiments described herein generally relate to methods (and associated systems configured to implement the methods) for determining one or more states of an autonomous vehicle for positioning when transitioning between two or more different environments.

In accordance with an example embodiment, there is provided a system for determining one or more states of an autonomous vehicle for positioning when transitioning between two or more different environments. The system includes a positioning system comprising two or more different positioning subsystems operable to generate positional data representing a current position of the autonomous vehicle, and the positional data comprising one or more prior states of the autonomous vehicle, one or more measurement uncertainties associated with the prior states of the autonomous vehicle and an acquisition time data associated with when each state was determined, each positioning subsystem being suitable for collecting the position data in respect of the autonomous vehicle in an environment of the two or more environments: and a processor in communication with the positioning system. The processor is operable to receive the positional data from each positioning subsystem of the two or more positioning subsystems: pre-process the positional data based on a common frame of reference determined for the autonomous vehicle: generate a plurality of estimated current states for the autonomous vehicle based at least on positional data received from each positioning subsystem and the one or more prior states of the autonomous vehicle: determine a plurality of weighting values for the plurality of positioning subsystems based on the estimated current states: and apply a respective weighting value generated for a positioning subsystem to a corresponding estimated current state generated for the positional data collected by the positioning subsystem to estimate a position of the autonomous vehicle when transitioning between the two or more different environments.

In some embodiments, the plurality of positioning subsystems is selected from: a GNSS subsystem, a cellular-based positioning subsystem, an inertial measurement unit, and one or more sensors.

In some embodiments, the one or more sensors are selected from: a camera, a LIDAR sensor.

In some embodiments, the processor is configured to generate corresponding maps based on sensor data generated by the each of the sensors and generate the positional data based on a comparison between a current map and a previously generated map.

In some embodiments, the processor is configured to generate corresponding maps based on sensor data generated by the each of the sensors and generate the positional data based on a comparison between a current map global map retrieved by the processor.

In some embodiments, the processor is operable to determine localization information for the autonomous vehicle based on the weighted positioning subsystems, the localization information comprising one or more of: a vehicle linear position, a vehicle linear velocity, a vehicle orientation, and a vehicle angular velocity.

In some embodiments, the processor is operable to generate the plurality of estimated current states of the autonomous vehicle based on a vehicle dynamic model and the acquisition time data.

In some embodiments, each of the estimated current states are defined by a distribution and wherein the processor is operable to determine the weighting value for the positional subsystems based on a measure of spread in the distribution.

In some embodiments, the processor is operable to normalize coordinates of the positional data to the common frame of reference.

In some embodiments, the processor is operable to pre-process the positional data to remove noise.

In accordance with an embodiment, there is provided a method for determining one or more states of an autonomous vehicle for positioning when transitioning between two or more different environments. The method comprises operating a processor to: receive positional data from a positioning system, the positioning system each positioning subsystem comprising two or more different positioning subsystems operable to generate the positional data representing a current position of the autonomous vehicle, and the positional data comprising one or more prior states of the autonomous vehicle, one or more measurement uncertainties associated with the prior states of the autonomous vehicle and an acquisition time data associated with when each state was determined, each positioning subsystem being suitable for collecting the position data in respect of the autonomous vehicle in an environment of the two or more environments: pre-process the positional data based on a common frame of reference determined for the autonomous vehicle: generate a plurality of estimated current states for the autonomous vehicle based at least on positional data received from each positioning subsystem and the one or more prior states of the autonomous vehicle: determine a plurality of weighting values for the plurality of positioning subsystems based on the estimated current states: and apply a respective weighting value generated for a positioning subsystem to a corresponding estimated current state generated for the positional data collected by the positioning subsystem to estimate a position of the autonomous vehicle when transitioning between the two or more different environments.

In some embodiments, the plurality of positioning subsystems is selected from: a GNSS subsystem, a cellular-based positioning subsystem, an inertial measurement unit, and one or more sensors.

In some embodiments, the one or more sensors are selected from: a camera, a LIDAR sensor.

In some embodiments, the method further comprises operating the processor to generate corresponding maps based on sensor data generated by the each of the sensors and generate the positional data based on a comparison between a current map and a previously generated map.

In some embodiments, the method further comprises operating the processor to generate corresponding maps based on sensor data generated by the each of the sensors and generate the positional data based on a comparison between a current map global map retrieved by the processor.

In some embodiments, the method further comprises operating the processor to determine localization information for the autonomous vehicle based on the weighted positioning subsystems, the localization information comprising one or more of: a vehicle linear position, a vehicle linear velocity, a vehicle orientation and a vehicle angular velocity.

In some embodiments, the method further comprises operating the processor to estimate the current state of the autonomous vehicle based on a vehicle dynamic model and a current time stamp.

In some embodiments, each of the estimated current states are defined by a distribution and wherein the method further comprises operating the processor to determine the weighting value for the positional subsystems based on a measure of spread in the distribution.

In some embodiments, the method further comprises operating the processor to normalize coordinates of the positional data to the common frame of reference.

In some embodiments, the method further comprises operating the processor to preprocess each the positional data to remove noise.

### BRIEF DESCRIPTION OF THE DRAWINGS

Several embodiments will now be described in detail with reference to the drawings, in which:

FIG. 1A is a schematic diagram of an indoor positioning system for autonomous vehicles:

FIG. 1B is a schematic diagram of an outdoor positioning system for autonomous vehicles:

FIG. 2A is an exemplary block diagram of an example autonomous vehicle in communication with external components, in accordance with an example embodiment:

FIG. 2B is a block diagram of components of an example autonomous vehicle, in accordance with an embodiment:

FIG. 3 is a block diagram of components of another example autonomous vehicle, in accordance with an embodiment:

FIG. 4 is a flowchart of an example method for determining a driving directive and localization information for an autonomous vehicle, in accordance with an example embodiment:

FIG. 5. is a flowchart of another example method for determining a state of an autonomous vehicle, in accordance with an example embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DETAILED DESCRIPTION OF EXAMPLE EMBODIMENTS

Autonomous driving systems such as autonomous vehicles require high-precision and robust positioning systems for localization, since the operation of these driving systems relies on reliable and accurate localization information. Localization information is typically obtained using various systems, including sensor systems. For example, global navigation satellite systems (GNSS), inertial measurement units (IMU), wheel odometry, point cloud matching, visual localization are typically used for obtaining localization information. Existing positioning systems typically employ one or more of these systems to obtain this information.

For example, in cases where obtaining precise and accurate localization information is crucial to the operation of an autonomous driving system, two or more systems can be combined. Existing systems, however, are typically only adapted for operating in specific environments and are therefore often unreliable when the autonomous driving system moves from one environment to another, such as from indoor to outdoor environments or from rural to urban environments.

The disclosed systems and methods are adapted to reliably provide real-time localization information (e.g., position, velocity, orientation) by fusing positional data from a plurality of positional subsystems. Each of the positional subsystems can be particularly suited for particular environmental conditions. As will be described, by weighting the positional data from each of the positioning subsystems, the disclosed systems and methods can determine one or more states (e.g., localization information) for an autonomous vehicle operating in a wide range of environments and moving between different environments. For example, the disclosed systems and methods can be suited for determining localization information of a vehicle traveling from an indoor environment (e.g., tunnel, underground mine, indoor facility) to an outdoor environment, and vice versa.

The disclosed systems and methods can evaluate the confidence of each positional subsystem and update weighting values associated with each positional subsystem in real-time, as the vehicle is in operation.

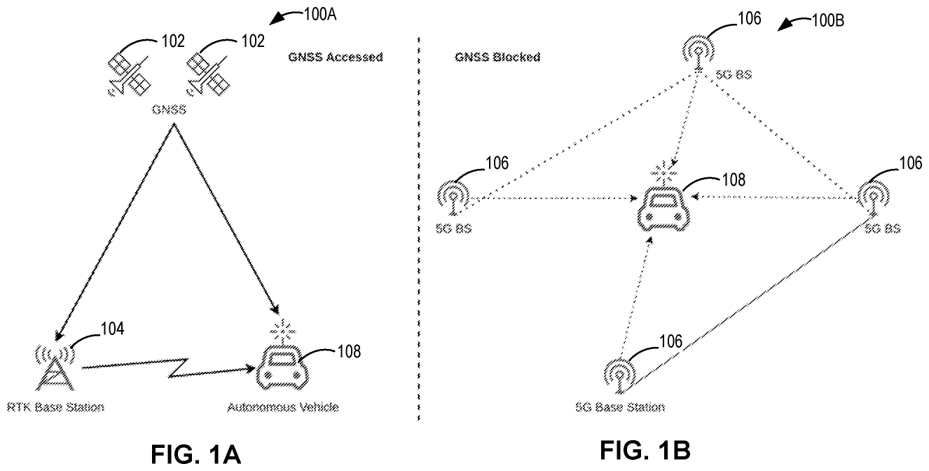

Reference is first made to FIGS. 1A-1B which show schematic diagrams of example outdoor and indoor positioning systems, respectively. As shown in FIG. 1A. existing outdoor positioning systems 100A typically involve the use of global navigation satellite systems (GNSS), such as global positioning systems (GPS) in order to determine a position of an autonomous vehicle 108. As is known to those skilled in the art of GNSS, conventional GNSS provide positioning information (e.g., position, velocity, orientation) by calculating the distance between a GNSS receiver (e.g., a receiver placed on the vehicle 108) and at least four satellites 102, based on the time taken for a signal to travel from the satellites 102 to the GNSS receiver. In some cases, outdoor positioning systems 100A are enhanced using real-time kinematic (RTK) positioning. RTK positioning can enhance the accuracy of standard GNSS, which can be affected by various error sources, such as atmospheric interference, satellite clock errors and multipath effects. In RTK-enhanced GNSS, the satellites 102 and the vehicle 108 are in communication with one or more base stations 104, which can receive and transmit signals. By determining a difference between the current measured position of the base station 104 and the known accurate position of the base station 104, the base station 104 can determine a correction factor, and transmit correction signals that are received by the GNSS receiver of the vehicle 108 to correct the position determined by positioning information provided by the GNSS.

As shown in FIG. 1B, when the vehicle 108 is operating indoors where GNSS signals can be blocked or unreliable, the position of the vehicle 108 is determined using information from one or more cellular-based base stations 106, for example 4G, 4G LTE or 5G base station beacons placed at fixed locations within the environment in which the vehicle 108 is expected to operate. The vehicle 108 can be in direct or indirect communication with the base stations 106 and each base station 106 can emit signals that can be received directly or indirectly by a receiver placed on the vehicle 108.

Based on the signal strength of the signals transmitted by the base stations 106 at the receiver and the known location of the base station 106, the vehicle 108 can determine its position. Alternatively, or in addition thereto, the vehicle 108 can determine its position based on the delay between the transmission time by the base station beacons 106 and the reception time by the receiver (i.e., the propagation delay). The positional data can then be transmitted and converted to vehicle guidance information.

As shown in FIGS. 1A-1B, example solutions require the use of different systems for determining the position of a vehicle 108 when the vehicle 108 is operating outdoors and when the vehicle is operating indoors.

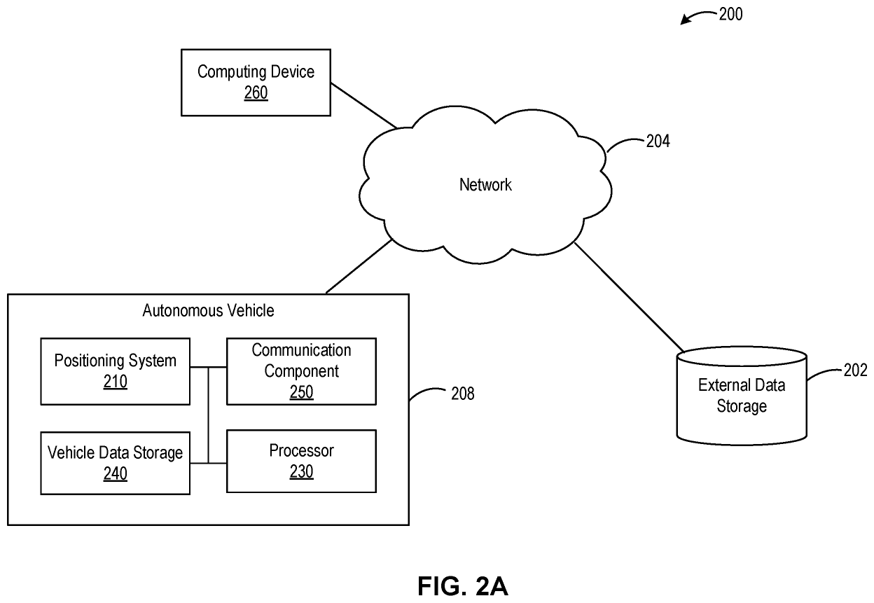

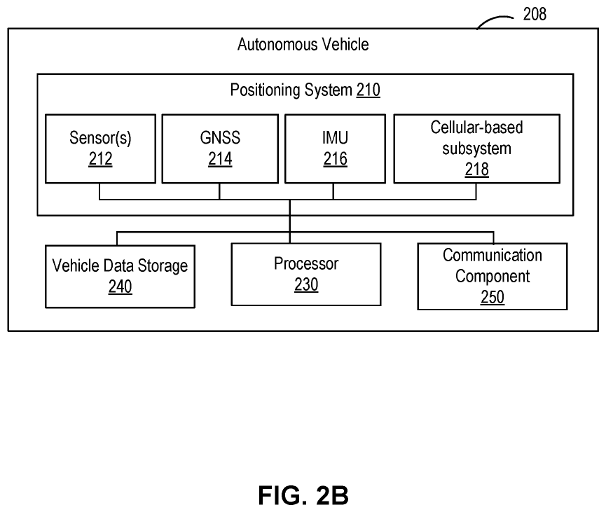

Reference is next made to FIG. 2A, which shows a block diagram of an autonomous vehicle 208 in communication with an external data storage 202 and a computing device 260 via a network 204.

The autonomous vehicle 208 can be a vehicle that operates autonomously or semi-autonomously based on control instructions. The autonomous vehicle 208 can include a positioning system 210, a processor 230, a vehicle data storage 240 and a communication component 250, as will be described in further detail below, with reference to FIG. 2B.

The external data storage 202 can include RAM, ROM, one or more hard drives, one or more flash drives or some other suitable data storage elements such as disk drives. The external data storage 202 can include one or more databases for storing data generated and/or collected by the autonomous vehicle 208, data used by a positioning system 210 of the autonomous vehicle 208 and/or data related to the operation of the autonomous vehicle 208, including but not limited to, instructions for operating the autonomous vehicle 208.

The network 204 can include any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between, the autonomous vehicle 208 and the external data storage 102.

The computing device 260 can include any device capable of communicating with other devices and with the autonomous vehicle 208 through a network such as the network 204. A network device can couple to the network 102 through a wired or wireless connection. The computing device 106 can include a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these. The computing device 260 can be configured to transmit instructions to the autonomous vehicle 208 and/or receive data from the autonomous vehicle 208. Although only one autonomous vehicle 208 is shown, the computing device 260 can be communication with more than one autonomous vehicle 208 and in some embodiments, the autonomous vehicle 208 can be in communication with one or more other autonomous vehicles 208 and transmit data to the one or more other autonomous vehicles 208. For example, the autonomous vehicle 208 can be in communication with one or more other autonomous vehicles 208 via the computing device 260.

Reference is next made to FIG. 2B, which shows a block diagram of example components of an autonomous vehicle 208. As shown, the autonomous vehicle 208 includes a positioning system 210 in communication with a processor 230, a vehicle data storage 240 and a communication component 250. The vehicle data storage 240, the processor 230 and the communication component 250 may be combined into a fewer number of components or may be separated into further components. The positioning system 210 includes positioning subsystems which can include two or more of one or more sensors 212, a GNSS 214, an inertial measurement unit 216 and a cellular-based subsystem 218. In some embodiments, some components of the positioning system 210 can be omitted. Further, though the processor 230, the vehicle data storage 240 and the communication component 250 are shown as separate from the positioning system 210, one or more of these components may be implemented within the positioning system 210. For example, the positioning system 210 can include the processor 230.

The processor 230 can be implemented with any suitable processor, controller, digital signal processor, graphics processing unit, application specific integrated circuits (ASICs), and/or field programmable gate arrays (FPGAs) that can provide sufficient processing power for the configuration, purposes and requirements of the autonomous vehicle 208. For example, the processor 230 can have sufficient processing power to control the operation of the autonomous vehicle 208. The processor 230 can include more than one processor with each processor being configured to perform different dedicated tasks. For example, the processor 230 can include a processor configured to control a drive system of the autonomous vehicle 208 and a processor configured to determine a state (e.g., position velocity, orientation) of the autonomous vehicle 208 based on information from the positioning system 210.

The vehicle data storage 240 can include RAM, ROM, one or more hard drives, one or more flash drives or some other suitable data storage elements such as disk drives, etc. The vehicle data storage 240 can include one or more databases for storing data received from the positioning system 210, fusion algorithms for using data from the positioning system 210, dynamic models of the autonomous vehicle 208, data relating to the operation of the autonomous vehicle 108 and operating instructions used by the processor 230. In some embodiments, some of the data can be stored in the external data storage 202.

The communication component 250 can include any interface that enables communication between the processor 230 and/or the vehicle data storage 240 and the positioning system 210 and/or that enables the autonomous vehicle 208 to communicate with other components and external devices and systems. For example, the communication component 250 can receive positional data from the positioning system 210 and store the positional data in the vehicle data storage 240. The processor 230 can then process the positional data according to the methods described herein.

The communication component 250 can include at least one of a serial port, a parallel port or a USB port, in some embodiments. The communication component 250 may also include an interface to component via one or more of an Internet, Local Area Network (LAN), Ethernet, Firewire, modem, fiber, or digital subscriber line connection. Various combinations of these elements may be incorporated within the communication component 250.

The positioning system 210 can generate positional data that represent a current position of the autonomous vehicle 208 via components 212, 214, 216 and/or 218, which can be processed by the processor 230. The positional data can include measured states (i.e., measurements generated and/or collected by the component) of the autonomous vehicle 208, the measurement uncertainty associated with each measured state as determined by the positioning subsystem and acquisition time data (e.g., time stamps) associated with the measured states. Each component 212, 214, 216 and/or 218 can generate and/or collect measured states at a different time frequency and accordingly the time stamps of the positional data associated with each positioning subsystem can vary. Each component 212, 214, 216 and/or 218 can be particularly well-suited for specific types of environments, as will be described below.

The sensor 212 can include any type of sensor that can independently sense data about the autonomous vehicle's 208 surroundings. For example, the sensor 212 can be a camera. As another example, the sensor 212 can be a light detecting and ranging (LIDAR) sensor. In some embodiments, the positioning system 210 can include more than one sensor 212, each generating position data.

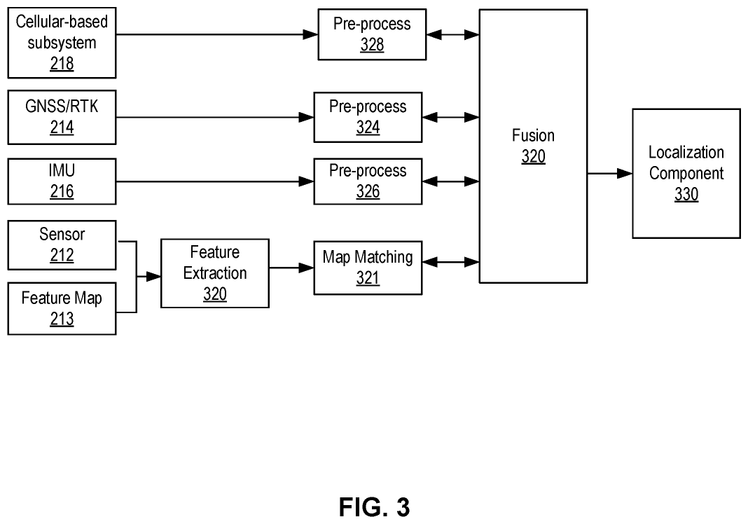

Data from the sensor 212 can be used in combination with a localization and/or mapping process to generate position data that defines the location of the autonomous vehicle 208. For example, the autonomous vehicle 208 can use sensor data from the sensor 212 and a simultaneous localization and mapping (SLAM) process. By sensing distances between the sensor 212 and objects in the autonomous vehicle's 208 environment, the autonomous vehicle 208 can create a map of the autonomous vehicle's 208 environment, as shown by component 213 of FIG. 3. As the autonomous vehicle 208 moves, the autonomous vehicle 208 can determine its location and orientation by comparing features extracted from a current map and a previously generated map. As shown in FIG. 3, features can be extracted by a feature extraction component 320 and the features of the current map and the features of the previously generated map can be matched using a map matching component 321. The features can be extracted using an image survey system which can include the feature extraction component 320, configured to extract features from maps. The location and/or orientation of the autonomous vehicle 208 can correspond to a global location and/or orientation if the initial position of the autonomous vehicle 208 is known or a relative location and/or orientation if the initial position of the autonomous vehicle 208 is unknown.

Alternatively, the autonomous vehicle 208 can compare a map generated by the autonomous vehicle 208 with a global map, for example, a global map stored in the vehicle data storage 240 or the external data storage 202 and the location and/or orientation of the autonomous vehicle is determined by matching features in the global map and features in the map generated by the autonomous vehicle 208.

The position and orientation of the autonomous vehicle 208 can be used to generate the sensor positional data. In some embodiments, sensor data from the sensor 212 can be transmitted as the positional data, and position and orientation information of the autonomous vehicle 208 can be determined at a later time.

The GNSS 214 can be a conventional GNSS enhanced with real-time kinematic (RTK) positioning as described with reference to FIG. 1A. In an RTK-enhanced GNSS, one or more base stations placed at fixed locations transmit corrections to one or more receivers on the autonomous vehicle 208. The receiver(s) can be the receiver(s) used for receiving GNSS signals. The GNSS 214 can generate GNSS positional data.

The inertial measurement unit (IMU) 216 can measure the acceleration and rotation rate of the autonomous vehicle 208 and generate positional data based on the measurements. The IMU 216 can include one or more accelerometers for measuring the linear acceleration of the autonomous vehicle 208, one or more gyroscopes for measuring the angular rate of the autonomous vehicle 208 and one or more magnetometers for measuring a magnetic field operating on the autonomous vehicle 208 to determine heading information of the autonomous vehicle 208.

The cellular-based subsystem 218 can include a plurality of base station beacons placed at predetermined locations within the environment in which the autonomous vehicle 108 is expected to operate. The cellular-based subsystem 218 can be similar to the indoor positioning system shown in FIG. 1B, wherein each base station is configured to transmit signals and a receiver placed on the autonomous vehicle 208 is configured to determine a location of the autonomous vehicle 208 based on a signal strength of the signals at the receiver and/or based on a delay between the transmission time of the base station beacons and the reception time at the receiver. The cellular-based subsystem 218 can be any type of cellular network system, for example, a 4G, a 4G LTE, a 5G-based subsystem or any subsequent generation cellular network system. The cellular-based subsystem 218 can generate cellular-based positional data.

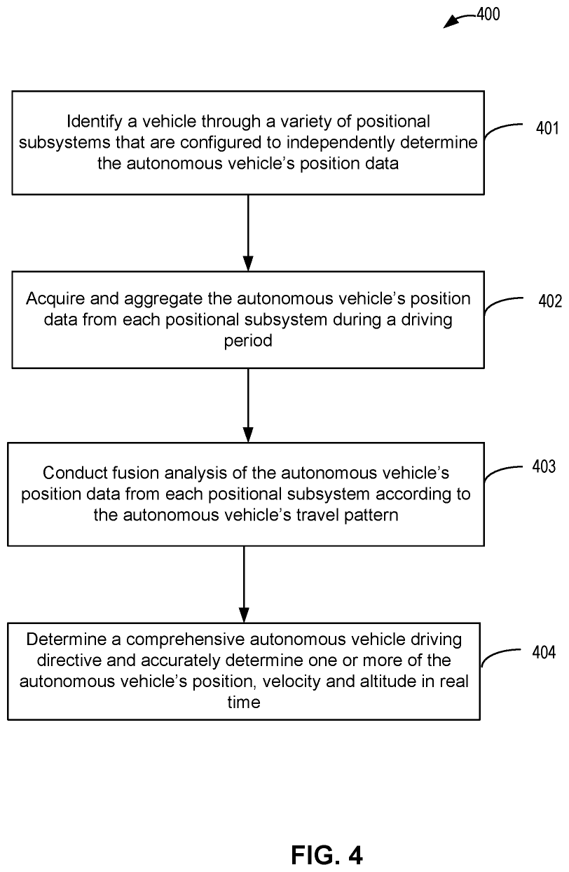

Reference is now made to FIG. 4, which shows a flowchart of an example method 400 of determining vehicle localization information using the fusion module 320 of FIG. 3. The method 400 can be performed by a processor, such as processor 230.

At 401, the processor 230 identifies a vehicle through the positioning subsystems 212, 213, 214, 216 and 218.

At 402, the processor 230 acquires and aggregates the vehicle's positional data from each positioning subsystem during a driving period and pre-processes the data as shown by components 320, 321, 326, 324 and 328 of FIG. 3. This pre-processing can include preprocessing positional data from the GNSS/RTK component 314, cellular-based subsystem component 318, the inertial measurement unit 216, the sensor 212, as well as acquiring and updating the feature maps 213, if available. Data from the inertial measurement unit 216 can be preprocessed by a strapdown inertial navigation system (SINS) module which can be implemented by the processor 230.

At 403, the processor 230 conducts fusion analysis of the vehicle's positional data from each positioning subsystem according to vehicle's travel pattern using the fusion module 320. The fusion module can be implemented by the processor 230. The fusion analysis includes assigning appropriate fusion weight to data from each subsystem, such that the appropriate emphasis can be placed to accommodate any dynamic driving scene changes.

At 404, the processor 230 determines a comprehensive vehicle driving directive and accurately determines the vehicle's positional parameters as shown by the localization component 330 in FIG. 3. This can include a linear position, a linear velocity, an angular velocity and orientation of the autonomous vehicle 208. The comprehensive driving directive can be generated and updated in real time, such that there is no interruption of data updates during the process.

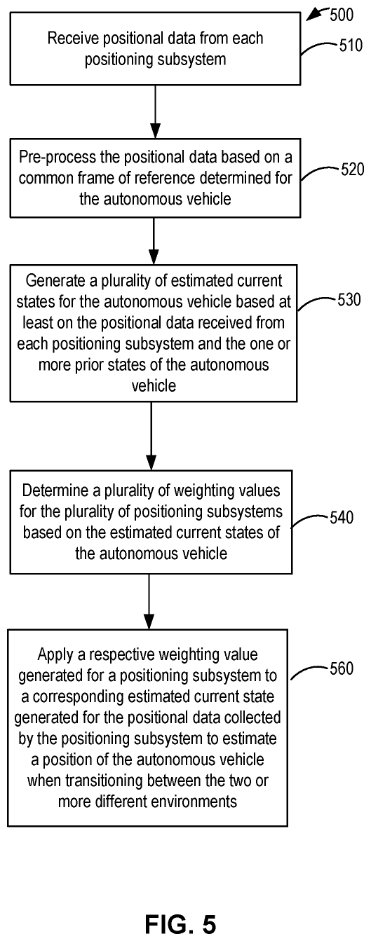

Reference is now made to FIG. 5, which shows a flowchart of an example method 500 of determining one or more states of the autonomous vehicle 208 for positioning the autonomous vehicle 208 when transitioning between two or more different environments. The method 500 can be implemented by processor 230.

At 510, the processor 230 receives positional data from the positioning system 210. The processor 230 can receive positional data from each of the components 212, 214, 216 and/or 218 separately. Alternatively, the positional data from the different positioning subsystems can be aggregated and the processor 230 can receive the aggregated positional data.

In some embodiments, the processor 230 pre-processes the positional data, for example, as shown by components 324, 326, 328 of FIG. 3. For example, the positional data associated with one or more of the positioning subsystems received at 510 can be unprocessed positional data. The data can be processed using a separate process, according to the type of data included in the positional data. For example, the positional data received from the sensor 212 can include sensor data and the processor 230 can be configured to determine a location and/or orientation of the autonomous vehicle 208 by performing feature map matching, as explained with reference to FIG. 2B. As another example, the positional data can be pre-processed to reduce or remove noise.

At 520, the processor 230 preprocesses the positional data received at 510 based on a common frame of reference. Since the positional data from the different positioning subsystems can have different frames of reference, the positional data can be normalized so that positional measurements are expressed using a common frame of reference. For example, positional data obtained from the IMU 216 can be defined relative to the initial position of the vehicle 208 while positional data obtained from the GNSS 214 can be defined as global coordinates (i.e., latitude and longitude). The processor 230 can determine a common frame of reference for the positional data and apply a pre-determined correction factor to the position data from one or more of the positioning subsystems so that the positional data are defined using a common frame of reference.

At 530, the processor 230 generates estimated current states for the autonomous vehicle's 208 based at least the position data received at 510 and one or more prior states of the autonomous vehicle. Since the position data from the different positioning subsystems can be associated with different data collection frequencies and data is collected or generated at discrete time intervals, the last measurements generated or obtained by each of the positioning subsystems 212, 214, 216 and 218 may not be associated with the same timing data (e.g., may not correspond to the current time stamp or the same time stamp). The processor 230) can estimate a state of the autonomous vehicle 208 at a particular time stamp (e.g., the current time stamp) using the pre-processed positional data to obtain a current state of the autonomous vehicle 208. For example, the IMU 216 can generate state measurements at a frequency of about 50-400 Hz, while the GNSS 214 can generate state measurements at a frequency of about 1-10 Hz. By estimating the state of the autonomous vehicle 208 at a specific time stamp using the positional data, the processor 230 can estimate a current state of the autonomous vehicle 208 as determined by each of the positioning subsystems 212, 214, 216, 218 for a common time stamp. The timestamp can be selected by the processor 230 and can correspond to a current timestamp.

For the position data of each of the positioning subsystems from which position data is received, the processor 230 can estimate the current state of the autonomous vehicle 208 based on a dynamic model of the autonomous vehicle 208 and one or more prior states (e.g., the last measured state) obtained or generated by the associated positional subsystem. The dynamic model of the autonomous vehicle 208 can be a model describing the derivative of the autonomous vehicle's 208 state, as described by Equation 1 below:

$$\dot{x} = Ax + B u \qquad ( 1 )$$

where \dot{x} is the derivative of the current state, A is the state transfer function of the autonomous vehicle 208, x is the previous state of the autonomous vehicle 208 as defined by the last measurements in the positional data, B is a control matrix and u is the control input.

The purpose of the vehicle dynamic model is to give a reference to fusion module to ensure that the trajectory of each input is consistent with vehicle dynamic constraint. A counterexample is that, if one GPS waypoint is drifted, the formed trajectory with previous waypoint may produce behavior like extremely fast acceleration or turning rate, which is physically infeasible that a vehicle can do. This situation will fail to validate by the vehicle dynamic model, and therefore lowering the weight of trust.

The state transfer function A, the control matrix B and the control input u can be retrieved by the processor 230 from memory, for example, from the vehicle data storage 240 or the external data storage 202. The control input u can be provided by a processor configured to control the operation of the autonomous vehicle 208. As explained previously, in some embodiments, the processor controlling the operation of the autonomous vehicle 208 is the processor 230. In other embodiments, the processor controlling the operation is different and separate from the processor 230.

By taking the integral of Equation 1, the current state of the autonomous vehicle 208 can be determined, as shown in Equation 2 below:

$${x}_{{T}_{current time} = {x}_{{T}_{previous}}} + {\int }_{{T}_{previous}}^{{T}_{current time}} {\dot{x}}_{previous} \qquad ( 2 )$$

The processor 230 can determine the current state of the autonomous vehicle 208 for the pre-processed positional data.

Since the positional data associated with each positioning subsystem includes measurement uncertainties, the current state of the autonomous vehicle 208 can be defined as a distribution, for example, a gaussian distribution or a normal distribution representative of the statistical dispersion of the estimated current state of the autonomous vehicle.

At 540, the processor 230 determines a weighting value for each of the positional subsystems based estimated current states estimated at 530. Current states characterized by a lower amount of spread in the distribution can be assigned a higher weighting value while current states characterized by a higher amount of spread in the distribution can be assigned a lower weighting value.

For example, the processor 230 can determine the standard deviation of each of the distributions and determine a weighting value based on the determined standard deviation. For example, positional data associated with lower standard deviation values can be assigned a higher weighting value, since lower standard deviation values can be associated with a higher confidence. Conversely, positional data associated with higher standard deviation values can be assigned a lower weighting value, since higher standard deviation values can be associated with lower confidence.

For example, since GNSS are particularly suited for outdoor environments, when the vehicle 208 is operating in an outdoor environment, the measurement uncertainty of the GNSS positional data can be low and accordingly processor's 230 confidence in the GNSS positional data can be high and the weighting value for the GNSS subsystem 214 can be high. Conversely, since cellular-based systems can be particularly suited for indoor environments or in environments where GNSS signal is occluded, when the vehicle 208 is operating in an indoor environment, the measurement uncertainty of the cellular-based subsystem positional data can be low and accordingly the processor's 230 confidence in the cellular-based subsystem positional data can be high and the weighting value for the cellular-based subsystem 218 can be high.

At 550, the processor 230 applies a respective weighting value generated for a positioning subsystem to an estimated current state generated for the positional data collected to estimate the position of the autonomous vehicle 208 when the autonomous vehicle 208 is transitioning between two environments. Since positional data associated with a higher confidence can be weighted more heavily than positional data associated with a lower confidence, weighting the positioning subsystems by the processor 230 can provide more accurate positioning information than if all positional data is weighted equally.

In some embodiments, the processor 230 obtains localization information for the autonomous vehicle 208 based on the weighted positioning subsystems. The localization information can include but is not limited to, a linear position, linear velocity, orientation and angular velocity of the autonomous vehicle 208. The determined localization of the autonomous vehicle 208 can be used to provide real time guidance to the autonomous vehicle 208. In some embodiments, localization information can be transmitted to external systems, for example, to update control personnel responsible for managing the autonomous vehicle 208.

Steps 510 to 550 can be repeated, as the autonomous vehicle 208 travels and obtains updated positional data. As the environment in which the autonomous vehicle 208 travel changes, the weighing values determined at 440 can also change. For example, when the autonomous vehicle 208 moves from an outdoor to an indoor environment, signals received by the GNSS 214 can deteriorate while signals obtained by the cellular-based subsystem 218 can improve. In this example, the confidence associated with the positional data obtained by the GNSS 214 can decrease when the autonomous vehicle 208 moves indoors while the confidence associated with the cellular-based subsystem positional data can improve. The weighting value associated with the GNSS positional data can accordingly decrease while the weighting value associated with the cellular-based subsystem positional data can increase.

The autonomous vehicle 208 can thus accommodate for changes in the autonomous vehicle's environment, without requiring the autonomous vehicle 208 to identify scene changes, since the weighting of each of the positional subsystems 212, 214, 216, 218 can be dynamically adjusted based on the positional data.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Numerous specific details are described herein in order to provide a thorough understanding of one or more embodiments of the described subject matter. It is to be appreciated, however, that some embodiments can be practiced without these specific details.

It is to be understood that the configurations and/or approaches described herein are exemplary in nature, and that the described embodiments, implementations and/or examples are not to be considered in a limiting sense but merely to offer example implementations.

What is claimed is:

1. A system for determining one or more states of an autonomous vehicle for positioning when transitioning between two or more different environments, the system comprising:
a positioning system comprising two or more different positioning subsystems operable to generate positional data representing a current position of the autonomous vehicle, and the positional data comprising one or more prior states of the autonomous vehicle, one or more measurement uncertainties associated with the prior states of the autonomous vehicle and an acquisition time data associated with when each state was determined, each positioning subsystem being suitable for collecting the position data in respect of the autonomous vehicle in an environment of the two or more environments: and
a processor in communication with the positioning system, the processor being operable to:
receive the positional data from each positioning subsystem of the two or more positioning subsystems:
pre-process the positional data based on a common frame of reference determined for the autonomous vehicle:
generate a plurality of estimated current states for the autonomous vehicle based at least on the positional data received from each positioning subsystem and the one or more prior states of the autonomous vehicle;
determine a plurality of weighting values for the plurality of positioning subsystems based on the estimated current states; and
apply a respective weighting value generated for a positioning subsystem to a corresponding estimated current state generated for the positional data collected by the positioning subsystem to estimate a position of the autonomous vehicle when transitioning between the two or more different environments.

2. The system of claim 1, wherein the plurality of positioning subsystems is selected from: a GNSS subsystem, a cellular-based positioning subsystem, an inertial measurement unit, and one or more sensors.

3. The system of claim 2, wherein the one or more sensors are selected from: a camera, a LIDAR sensor.

4. The system of claim 3, wherein the processor is configured to generate corresponding maps based on sensor data generated by the each of the sensors and generate the positional data based on a comparison between a current map and a previously generated map.

5. The system of claim 3, wherein the processor is configured to generate corresponding maps based on sensor data generated by the each of the sensors and generate the positional data based on a comparison between a current map global map retrieved by the processor.

6. The system of claim 1, wherein the processor is operable to determine localization information for the autonomous vehicle based on the weighted positioning subsystems, the localization information comprising one or more of: a vehicle linear position, a vehicle linear velocity, a vehicle orientation, and a vehicle angular velocity.

7. The system of claim 1, wherein the processor is operable to generate the plurality of estimated current states of the autonomous vehicle based on a vehicle dynamic model and the acquisition time data.

8. The system of claim 1, wherein each of the estimated current states are defined by a distribution and wherein the processor is operable to determine the weighting value for the positional subsystems based on a measure of spread in the distribution.

9. The system of claim 1, wherein the processor is operable to normalize coordinates of the positional data to the common frame of reference.

10. The system of claim 1, wherein the processor is operable to pre-process the positional data to remove noise.

11. A method for determining one or more states of an autonomous vehicle for positioning when transitioning between two or more different environments, the method comprising operating a processor to:
receive positional data from a positioning system, the positioning system each positioning subsystem comprising two or more different positioning subsystems operable to generate the positional data representing a current position of the autonomous vehicle, and the positional data comprising one or more prior states of the autonomous vehicle, one or more measurement uncertainties associated with the prior states of the autonomous vehicle and an acquisition time data associated with when each state was determined, each positioning subsystem being suitable for collecting the position data in respect of the autonomous vehicle in an environment of the two or more environments:
pre-process the positional data based on a common frame of reference determined for the autonomous vehicle:
generate a plurality of estimated current states for the autonomous vehicle based at least on the positional data received from each positioning subsystem and the one or more prior states of the autonomous vehicle:
determine a plurality of weighting values for the plurality of positioning subsystems based on the estimated current states: and
apply a respective weighting value generated for a positioning subsystem to a corresponding estimated current state generated for the positional data collected by the positioning subsystem to estimate a position of the autonomous vehicle when transitioning between the two or more different environments.

12. The method of claim 11, wherein the plurality of positioning subsystems is selected from: a GNSS subsystem, a cellular-based positioning subsystem, an inertial measurement unit, and one or more sensors.

13. The method of claim 12, wherein the one or more sensors are selected from: a camera, a LIDAR sensor.

14. The method of claim 13, further comprising operating the processor to generate corresponding maps based on sensor data generated by the each of the sensors and generate the positional data based on a comparison between a current map and a previously generated map.

15. The method of claim 13, further comprising operating the processor to generate corresponding maps based on sensor data generated by the each of the sensors and generate the positional data based on a comparison between a current map global map retrieved by the processor.

16. The method of claim 11, further comprising operating the processor to determine localization information for the autonomous vehicle based on the weighted positioning subsystems, the localization information comprising one or more of: a vehicle linear position, a vehicle linear velocity, a vehicle orientation and a vehicle angular velocity.

17. The method of claim 11, further comprising operating the processor to estimate the current state of the autonomous vehicle based on a vehicle dynamic model and a current time stamp.

18. The method of claim 11, wherein each of the estimated current states are defined by a distribution and wherein the method further comprises operating the processor to determine the weighting value for the positional subsystems based on a measure of spread in the distribution.

19. The method of claim 11, further comprising operating the processor to normalize coordinates of the positional data to the common frame of reference.

20. The method of claim 11, further comprising operating the processor to preprocess each the positional data to remove noise.
